(19) United States
(12) Patent Application Publication
(10) Pub. No.: US 2024/0055581 A1
(43) Pub. Date: Feb. 15, 2024

(54) POSITIVE PLATE FOR NONAQUEOUS RECHARGEABLE BATTERY, NONAQUEOUS RECHARGEABLE BATTERY, METHOD OF MANUFACTURING POSITIVE PLATE FOR NONAQUEOUS RECHARGEABLE BATTERY, AND METHOD OF MANUFACTURING NONAQUEOUS RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventor: Ryotaro SAKAI, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/231,040

(22) Filed: Aug. 7, 2023

(30) Foreign Application Priority Data
Aug. 10, 2022 (JP) 2022-128381

(51) Int. Cl. H01M 4/36; H01M 10/0525; H01M 4/62; H01M 4/04

(52) U.S. Cl. CPC H01M 4/364; H01M 10/0525; H01M 4/625; H01M 4/0416; H01M 2004/028

(57) ABSTRACT

A positive plate for a nonaqueous rechargeable battery includes a positive electrode substrate and a positive electrode mixture layer that contains at least a positive electrode active material. Particles of the positive electrode active material having a specific surface area of a range of 1.5 m²/g to 3.0 m²/g prior to manufacture of the positive plate for the nonaqueous rechargeable battery are used. A difference between a specific surface area of the positive plate for the nonaqueous rechargeable battery after manufacturing the positive plate for the nonaqueous rechargeable battery and the specific surface area of the particles of the positive electrode active material prior to manufacture of the positive plate for the nonaqueous rechargeable battery is in a range of 0.66 m²/g to 1.8 m²/g.

### BACKGROUND

### 1. Field

The present disclosure relates to a positive plate for a nonaqueous rechargeable battery, a nonaqueous rechargeable battery, a method of manufacturing a positive plate for a nonaqueous rechargeable battery, and a method of manufacturing a nonaqueous rechargeable battery. More specifically, the present disclosure relates to a positive plate for a nonaqueous rechargeable battery, a nonaqueous rechargeable battery, a method of manufacturing a positive plate for a nonaqueous rechargeable battery, and a method of manufacturing a nonaqueous rechargeable battery that improve characteristics of a nonaqueous rechargeable battery.

### 2. Description of Related Art

Conventionally, a nonaqueous rechargeable battery includes an electrode body having a negative plate, a positive plate, and separators. Such an electrode body is accommodated in a battery case together with a nonaqueous electrolyte solution in a state in which the negative plate, the positive plate, and the separators are stacked in a stacking direction. In each electrode plate, an electrode mixture layer is formed on an electrode substrate, and the electrode mixture layer contains at least an active material. When each electrode plate is manufactured, the specific surface area of the electrode plate affects the characteristics of the nonaqueous rechargeable battery, such as the capacity of the nonaqueous rechargeable battery.

As a method of manufacturing such a nonaqueous rechargeable battery, for example, Japanese Laid-Open Patent Publication No. 2003-272611 discloses a method in which a positive electrode active material having a specific surface area in a range of 0.6 m²/g to 1.5 m²/g is used, so that a positive plate has a specific surface area in a range of 0.5 m²/g to 2 m²/g. This provides a nonaqueous rechargeable battery having excellent discharge and output characteristics.

However, in the disclosure of Japanese Laid-Open Patent Publication No. 2003-272611, it is desired to further improve the characteristics of the nonaqueous rechargeable battery by using a new indicator for the specific surface area during the production of the positive plate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a positive plate for a nonaqueous rechargeable battery includes a positive electrode substrate and a positive electrode mixture layer that contains at least a positive electrode active material. Particles of the positive electrode active material having a specific surface area of a range of 1.5 m²/g to 3.0 m²/g prior to manufacture of the positive plate for the nonaqueous rechargeable battery are used. A difference between a specific surface area of the positive plate for the nonaqueous rechargeable battery after manufacturing the positive plate for the nonaqueous rechargeable battery and the specific surface area of the particles of the positive electrode active material prior to manufacture of the positive plate for the nonaqueous rechargeable battery is in a range of 0.66 m²/g to 1.8 m²/g.

In another general aspect, a nonaqueous rechargeable battery includes a positive plate. The positive plate includes a positive electrode substrate and a positive electrode mixture layer that contains at least a positive electrode active material. Particles of the positive electrode active material having a specific surface area of a range of 1.5 m²/g to 3.0 m²/g prior to manufacture of the positive plate are used. A difference between a specific surface area of the positive plate after manufacturing the positive plate and the specific surface area of the particles of the positive electrode active material prior to manufacture of the positive plate for the nonaqueous rechargeable battery is in a range of 0.66 m²/g to 1.8 m²/g.

In another general aspect, a method of manufacturing a positive plate for a nonaqueous rechargeable battery is provided. The positive plate for the nonaqueous rechargeable battery includes a positive electrode substrate and a positive electrode mixture layer that contains at least a positive electrode active material. Particles of the positive electrode active material having a specific surface area of a range of 1.5 m²/g to 3.0 m²/g prior to manufacture of the positive plate for the nonaqueous rechargeable battery are used. A difference between a specific surface area of the positive plate for the nonaqueous rechargeable battery after manufacturing the positive plate for the nonaqueous rechargeable battery and the specific surface area of the particles of the positive electrode active material prior to manufacture of the positive plate for the nonaqueous rechargeable battery is in a range of 0.66 m²/g to 1.8 m²/g.

In the above-described method of manufacturing the positive plate for the nonaqueous rechargeable battery, a density of the positive electrode mixture layer may be in a range of 2.2 mg/cm³ to 3.0 mg/cm³ after manufacturing the positive plate for the nonaqueous rechargeable battery.

In the above-described method of manufacturing the positive plate for the nonaqueous rechargeable battery, the positive electrode active material may be a ternary positive electrode active material.

In the above-described method of manufacturing the positive plate for the nonaqueous rechargeable battery, the positive electrode mixture layer may include a positive electrode conductive material, and the positive electrode conductive material may be one of carbon nanotubes or carbon nanofibers that have a specific surface area in a range of 150 m²/g to 300 m²/g prior to manufacture of the positive plate for the nonaqueous rechargeable battery.

In the above-described method of manufacturing the positive plate for the nonaqueous rechargeable battery, the positive electrode mixture layer may be provided on the positive electrode substrate by drying a positive electrode mixture paste applied to the positive electrode substrate. The positive electrode mixture paste may contain at least the positive electrode active material and a positive electrode solvent. The positive electrode solvent may be a nonaqueous solvent.

In another general aspect, a method of manufacturing a nonaqueous rechargeable battery including a positive plate is provided. The positive plate includes a positive electrode substrate and a positive electrode mixture layer that contains at least a positive electrode active material. Particles of the positive electrode active material having a specific surface area of a range of 1.5 m²/g to 3.0 m²/g prior to manufacture of the positive plate are used. A difference between a specific surface area of the positive plate after manufacturing the positive plate and the specific surface area of the particles of the positive electrode active material prior to manufacture of the positive plate for the nonaqueous rechargeable battery is in a range of 0.66 m²/g to 1.8 m²/g.

The present disclosure improves the characteristics of the nonaqueous rechargeable battery.

Other features and aspects will be apparent from the following detailed description, the drawings, and the claims.

### BRIEF DESCRIPTION OF THE DRAWINGS

FIG. 1 is a perspective view of a lithium-ion rechargeable battery according to an embodiment.

FIG. 2 is a schematic diagram showing a configuration of a stacked body of an electrode body of the lithium-ion rechargeable battery.

FIG. 3 is a flowchart showing a battery element producing process of an electrode plate for the lithium-ion rechargeable battery.

FIG. 4 is a table showing examples and comparative examples of the lithium-ion rechargeable battery.

FIG. 5 is a schematic diagram showing a positive plate.

FIG. 6 is a schematic diagram showing a positive plate.

FIG. 7 is a schematic diagram showing a positive plate.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

A positive plate for a nonaqueous rechargeable battery, a nonaqueous rechargeable battery, a method of manufacturing a positive plate for a nonaqueous rechargeable battery, and a method of manufacturing a nonaqueous rechargeable battery according to an embodiment will now be described.

<Lithium-Ion Rechargeable Battery 10>

A structure of a lithium-ion rechargeable battery 10 will be described as an example of a nonaqueous rechargeable battery.

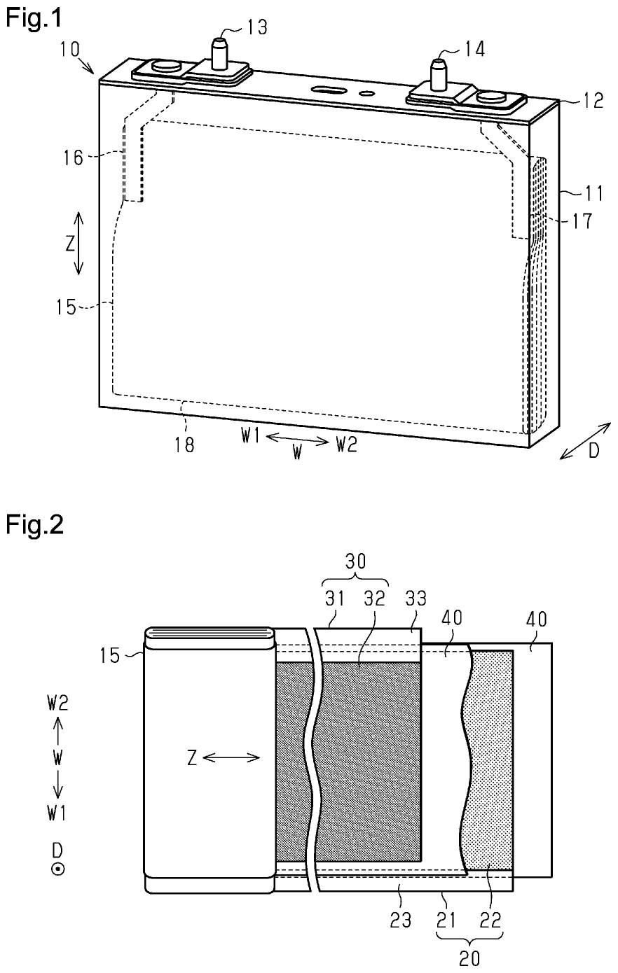

As shown in FIG. 1, the lithium-ion rechargeable battery 10 is configured as a cell. The lithium-ion rechargeable battery 10 includes a battery case 11. The battery case 11 includes a lid 12. The battery case 11 has an opening (not shown) on the upper side. The lid 12 seals the opening. The battery case 11 is made of a metal such as an aluminum alloy. The lid 12 includes a negative electrode external terminal 13 and a positive electrode external terminal 14 used to charge and discharge electric power. The negative electrode external terminal 13 and the positive electrode external terminal 14 may have any shape.

The lithium-ion rechargeable battery 10 includes an electrode body 15. The lithium-ion rechargeable battery 10 includes a negative electrode current collector 16 and a positive electrode current collector 17. The negative electrode current collector 16 connects the negative electrode of the electrode body 15 to the negative electrode external terminal 13. The positive electrode current collector 17 connects the positive electrode of the electrode body 15 to the positive electrode external terminal 14. The electrode body 15 is accommodated in the battery case 11.

The lithium-ion rechargeable battery 10 includes nonaqueous electrolyte solution 18. The nonaqueous electrolyte solution 18 is injected into the battery case 11 through an injection hole (not shown). In the lithium-ion rechargeable battery 10, the lid 12 is attached to the opening of the battery case 11 to form a sealed electrolyte cell. In this manner, the battery case 11 accommodates the electrode body 15 and the nonaqueous electrolyte solution 18.

<Nonaqueous Electrolyte Solution 18>

The nonaqueous electrolyte solution 18 is a composition in which a nonaqueous solvent contains supporting salt. In the present embodiment, ethylene carbonate (EC) can be used as the nonaqueous solvent. The nonaqueous solvent may be one or more materials selected from the group consisting of propylene carbonate (PC), diethyl carbonate (DEC), dimethyl carbonate (DMC), ethyl methyl carbonate (EMC), and the like.

As the supporting salt, LiPF₆, LiBF₄, LiClO₄, LiAsF₆, LiCF₃SO₃, LiC₄F₉SO₃, LiN(CF₃SO₂)₂, LiC(CF₃SO₂)₃, LiI and the like can be used. As the supporting salt, one or multiple lithium compounds (lithium salts) selected from these compounds can be used. As described above, the nonaqueous electrolyte solution 18 contains a lithium compound.

<Electrode Body 15>

As shown in FIG. 2, the electrode body 15 includes a negative plate 20, a positive plate 30, and separators 40. The longitudinal direction of the electrode body 15 will be referred to as a length direction Z. The thickness direction of the electrode body 15 will be referred to as a thickness direction D. A direction intersecting the length direction Z and the thickness direction D of the electrode body 15 will be referred to as a width direction W. One direction in the width direction W will be referred to as a first width direction W1, and the other direction in the width direction W will be referred to as a second width direction W2. The second width direction W2 is a direction opposite to the first width direction W1.

In the electrode body 15, the negative plate 20, the positive plate 30, and the separators 40 are stacked in the thickness direction D. Each separator 40 is provided between the negative plate 20 and the positive plate 30. Specifically, in the electrode body 15, one of the separators 40, the positive plate 30, the other separator 40, and the negative plate 20 are stacked in that order.

The electrode body 15 is rolled in the length direction Z in a state in which the negative plate 20, the positive plate 30, and the separators 40 are stacked in the thickness direction D. The electrode body 15 has a flat shape in the thickness direction D at the center in the length direction Z.

As described above, the thickness direction D, in which the negative plate 20, the positive plate 30, and the separators 40 are stacked, can also be referred to as a stacking direction. The length direction Z, in which the negative plate 20, the positive plate 30, and the separators 40 are rolled, can also be referred to as a rolling direction. The electrode body 15 has a flat shape in the thickness direction D.

<Negative Plate 20>

The negative plate 20 functions as an example of a negative electrode of the lithium-ion rechargeable battery 10. The negative plate 20 includes a negative electrode substrate 21 and a negative electrode mixture layer 22. The negative electrode substrate 21 is an electrode substrate of a negative electrode. The negative electrode mixture layer 22 is an electrode mixture layer of a negative electrode, and is provided on both surfaces of the negative electrode substrate 21.

The negative electrode substrate 21 includes a negative electrode connection portion 23. The negative electrode connection portion 23 is a region where the negative electrode mixture layer 22 is not provided on either side of the negative electrode substrate 21. The negative electrode connection portion 23 is provided at an end portion of the electrode body 15 in the first width direction W1. The negative electrode connection portion 23 is exposed from the positive plate 30 and the separators 40 in the first width direction W1.

In the present embodiment, the negative electrode substrate 21 is made of a Cu foil. The negative electrode substrate 21 is a base that serves as an aggregate of the negative electrode mixture layer 22. The negative electrode substrate 21 has a function of a current collecting member that collects electricity from the negative electrode mixture layer 22.

The negative electrode mixture layer 22 includes a negative electrode active material and a negative electrode additive. The negative plate 20 is manufactured by, for example, kneading a negative electrode active material and a negative electrode additive, applying the kneaded negative electrode mixture paste to the negative electrode substrate 21, and drying the negative electrode mixture paste.

In the present embodiment, the negative electrode active material is an active material of the negative electrode and is a material capable of storing and desorbing lithium ions. As the negative electrode active material, for example, a powdery carbon material made of graphite or the like can be used.

The negative electrode additive is an additive of the negative electrode, and includes a negative electrode solvent, a negative electrode binder, and a negative electrode thickener. As the negative electrode solvent, for example, water or the like can be used. As the negative electrode binder, for example, styrene-butadiene rubber (SBR), polyvinylidene fluoride (PVDF), polyvinyl alcohol (PVA) or the like can be used. As the negative electrode thickener, for example, carboxymethyl cellulose (CMC) or the like can be used. The negative electrode additive may further include, for example, a negative electrode conductive material or the like.

<Positive Plate 30>

The positive plate 30 functions as an example of a positive electrode of the lithium-ion rechargeable battery 10. The positive plate 30 includes a positive electrode substrate 31 and a positive electrode mixture layer 32. The positive electrode substrate 31 is an electrode substrate of a positive electrode. The positive electrode mixture layer 32 is an electrode mixture layer of a positive electrode, and is provided on both surfaces of the positive electrode substrate 31.

The positive electrode substrate 31 includes a positive electrode connection portion 33. The positive electrode connection portion 33 is a region where the positive electrode mixture layer 32 is not provided on either side of the positive electrode substrate 31. The positive electrode connection portion 33 is provided at an end portion of the electrode body 15 in the second width direction W2. The positive electrode connection portion 33 is exposed from the negative plate 20 and the separators 40 in the second width direction W2.

In the present embodiment, the positive electrode substrate 31 is made of an Al foil or an Al alloy foil. The positive electrode substrate 31 is a base that serves as an aggregate of the positive electrode mixture layer 32. The positive electrode substrate 31 has a function of a current collecting member that collects electricity from the positive electrode mixture layer 32.

The positive electrode mixture layer 32 includes a positive electrode active material and a positive electrode additive. The positive plate 30 is manufactured by, for example, kneading a positive electrode active material and a positive electrode additive, applying the kneaded positive electrode mixture paste to the positive electrode substrate 31, and drying the negative electrode mixture paste.

The positive electrode active material is an active material of the positive electrode and is a material capable of storing and desorbing lithium. One example of the positive electrode active material is ternary (NMC) lithium-containing composite oxide containing nickel, manganese, and cobalt, such as nickel-cobalt-manganese lithium (LiNiCoMnO₂). As the positive electrode active material, for example, any one of lithium cobalt oxide (LiCoO₂), lithium manganese oxide (LiMn₂O₄), and lithium nickel oxide (LiNiO₂) may be used. As the positive electrode active material, for example, a lithium-containing composite oxide containing nickel, cobalt, and aluminum (NCA) may be used.

The positive electrode additive is an additive of the positive electrode, and includes a positive electrode solvent, a positive electrode conductive material, and a positive electrode binder. As the positive electrode solvent, for example, a nonaqueous solvent such as N-methyl-2-pyrrolidone (NMP) solution can be used. As the positive electrode conductive material, for example, carbon fibers such as carbon nanotubes (CNT) and carbon nanofibers (CNF) can be used. In addition, carbon black such as graphite, acetylene black (AB), and Ketjen black may also be used. As the positive electrode binder, for example, a binder similar to the negative electrode binder can be used. The positive electrode additive may further include, for example, a positive electrode thickener or the like.

<Separators 40>

Each separator 40 is provided between the negative plate 20 and the positive plate 30. The separator 40 holds the nonaqueous electrolyte solution 18. The separator 40 is a nonwoven fabric made of a porous plastic such as polypropylene. As the separator 40, a porous polymer membrane such as a porous polyethylene membrane, a porous polyolefin membrane, and a porous polyvinyl chloride membrane, or lithium ion or ion conductive polymer electrolyte membrane can be used alone or in combination. When the electrode body 15 is immersed in the nonaqueous electrolyte solution 18, the nonaqueous electrolyte solution 18 permeates from the end portion of the separator 40 toward the central portion.

<Manufacturing Process of Lithium-Ion Rechargeable Battery 10>

A manufacturing process of the lithium-ion rechargeable battery 10 of the present embodiment will now be described.

In the present embodiment, a battery element producing process is performed. As will be discussed below, the battery element producing process is a process of producing a battery element of the lithium-ion rechargeable battery 10. Specifically, the battery element producing process is a process of producing each of the negative plate 20 and the positive plate 30, which form the battery element of the lithium-ion rechargeable battery 10.

When the battery element producing process is completed, an assembly process is performed. The assembly process is an assembly process of assembling the lithium-ion rechargeable battery 10. In the assembly process, the electrode body 15 is manufactured first. Specifically, the positive plate 30 and the negative plate 20 are stacked with the separator 40 interposed in between, rolled, and pressed into a flat shape. Thereafter, overlapping sections of the negative electrode connection portion 23 are pressed together, and overlapping sections of the positive electrode connection portion 33 is pressed together. The electrode body 15 is manufactured by the procedure described above.

Next, the electrode body 15 is accommodated in the battery case 11. At this time, the positive electrode connection portion 33 is electrically connected to the positive electrode external terminal 14 via the positive electrode current collector 17. The negative electrode connection portion 23 is electrically connected to the negative electrode external terminal 13 via the negative electrode current collector 16. The opening of the battery case 11 is closed by the lid 12. Then, the nonaqueous electrolyte solution 18 is injected into the battery case 11. When the injection of the nonaqueous electrolyte solution 18 into the battery case 11 is completed, the battery case 11 is sealed. The lithium-ion rechargeable battery 10 is assembled by the procedure described above.

<Battery Element Producing Process>

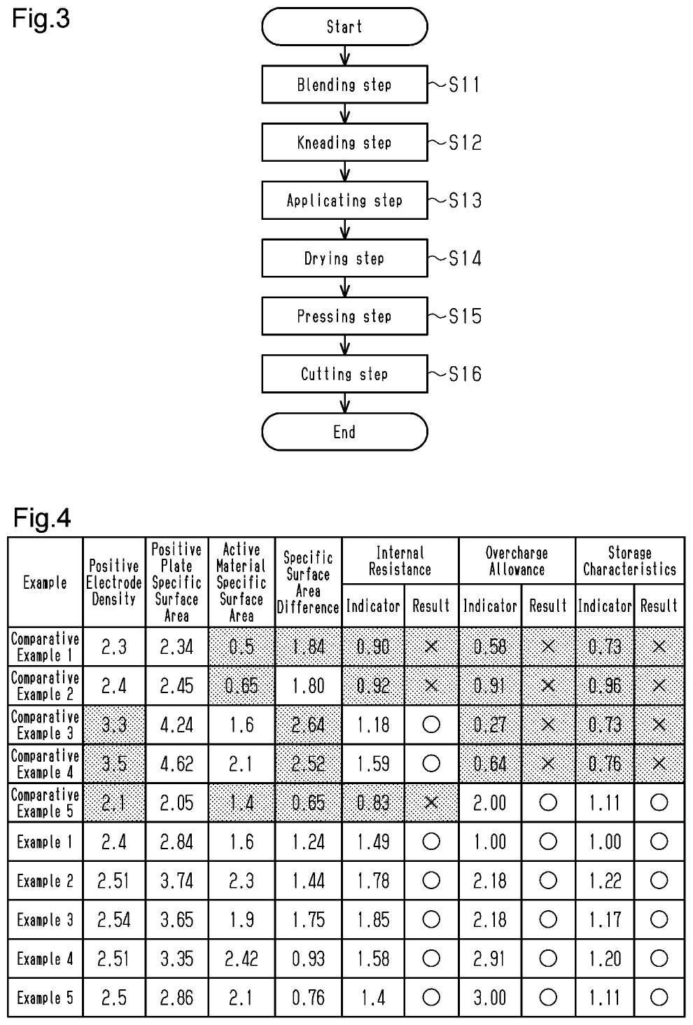

The battery element producing process of the present embodiment will now be described with reference to FIG. 3. Hereinafter, the process of producing the positive plate 30 will be described, and the description of the process of producing the negative plate 20 will be omitted.

As shown in FIG. 3, a blending step is performed in step S11. The blending step includes a step of blending a positive electrode active material and a positive electrode additive, which are raw materials of the positive electrode mixture layer 32. Accordingly, a positive electrode mixture paste is produced. In step S12, a kneading step is performed. The kneading step includes a step of kneading the positive electrode mixture paste.

After the kneading step, an applicating step is performed in step S13. In the applicating step, the positive electrode mixture paste is applied to both surfaces of the positive electrode substrate 31 to form the positive electrode connection portion 33 at the opposite ends in the width direction W. A drying step is then performed in step S14. In the drying step, the positive electrode mixture paste applied to the positive electrode substrate 31 is dried to form the positive electrode mixture layer 32.

After the drying step, a pressing step is performed in step S15. In the pressing step, the positive electrode mixture layer 32 formed on both surfaces of the positive electrode substrate 31 is pressed to increase the adhesion strength of the positive electrode mixture layer 32 to the positive electrode substrate 31 and adjust the thickness of the positive electrode mixture layer 32.

After the pressing step, a cutting step is performed in step S16. In the cutting step, the positive plate 30 is cut at the center in the width direction W. Two strips of the positive plates 30 are manufactured at a time by the above-described steps.

<Method of Manufacturing Positive Plate 30>

A method of manufacturing the positive plate 30 will now be described in detail.

The positive plate 30 is manufactured based on the specific surface area of the positive electrode active material before manufacturing the positive plate 30 and the specific surface area of the positive plate 30 after manufacturing the positive plate 30. The specific surface area is measured by, for example, a gas adsorption measurement method using the BET equation, that is, by the BET method.

Before manufacturing the positive plate 30, particles having a specific surface area in a range of 1.5 m²/g to 3.0 m²/g are used as the positive electrode active material. “Before manufacturing the positive plate 30” means before the blending step is performed in the battery element producing process. In other words, the specific surface area of the positive electrode active material before manufacturing the positive plate 30 is the specific surface area of the positive electrode active material particles before being blended in the blending step. As described above, the specific surface area of the positive electrode active material before manufacturing the positive plate 30 is in a range of 1.5 m²/g to 3.0 m²/g. Hereinafter, the specific surface area of the positive electrode active material before manufacturing the positive plate 30 may be referred to as an active material specific surface area.

After manufacturing the positive plate 30, the density of the positive electrode mixture layer 32 is in a range of 2.2 mg/cm³ to 3.0 mg/cm³. “After manufacturing the positive plate 30” means after the battery element producing process is performed. As described above, the density of positive electrode mixture layer 32 after manufacturing the positive plate 30 is in a range of 2.2 mg/cm³ to 3.0 mg/cm³. In addition, the density of the positive electrode mixture layer 32 after manufacturing the positive plate 30 is equal to the density of the positive electrode mixture layer 32 after the pressing step is performed. Hereinafter, the density of the positive electrode mixture layer 32 after manufacturing the positive plate 30 may be referred to as positive electrode density.

In addition, the positive plate 30 is manufactured such that the difference between the specific surface area of the positive plate 30 after manufacturing the positive plate 30 and the specific surface area of the positive electrode active material (active material specific surface area) before manufacturing the positive plate 30 is in a range of 0.66 m²/g to 1.8 m²/g. Specifically, the specific surface area of the positive plate 30 after manufacturing the positive plate 30 is the specific surface area of the positive electrode mixture layer 32 of the positive plate 30 after manufacturing the positive plate 30. The specific surface area of the positive plate 30 after manufacturing the positive plate 30 is adjusted in the pressing step based on the difference from the specific surface area of the positive electrode active material. The specific surface area of the positive plate 30 after manufacturing the positive plate 30 is equal to the specific surface area of the positive plate 30 after the pressing step. In other words, the specific surface area of the positive plate 30 after manufacturing the positive plate 30 is the specific surface area of the positive plate 30 after being pressed in the pressing step. Hereinafter, the specific surface area of the positive plate 30 after manufacturing the positive plate 30 may be referred to as a positive plate specific surface area. In addition, the difference between the positive plate specific surface area and the active material specific surface area may be referred to as a specific surface area difference.

### Examples and Comparative Examples

Examples and comparative examples of the lithium-ion rechargeable battery 10 will now be described with reference to FIG. 4. In the examples and the comparative examples, determinations were performed under the following conditions, but these are merely examples, and the present disclosure is not limited thereto. In the examples and the comparative examples, lithium-ion rechargeable batteries 10 having a capacity (C) rate of 50 C and a state of charge (SOC) of 20 to 90% were evaluated.

In the examples and the comparative examples, ternary lithium-containing composite oxide or lithium-containing composite oxide containing nickel cobalt aluminum (NCA) was used as the positive electrode active material. In the examples and the comparative examples, the positive plate specific surface area was adjusted by pressing in the pressing step. For the pressing in the pressing step, a pressing pressure of 50 to 196 kN and a pressing speed of 6 to 60 m/min were employed.

In the examples and the comparative examples, for example, a powdery carbon material made of graphite or the like was used as the negative electrode active material. In the examples and the comparative examples, a nonaqueous solvent was used as the solvent of the nonaqueous electrolyte solution 18, and one or more materials selected from the group consisting of ethylene carbonate, ethyl methyl carbonate, dimethyl carbonate, and the like were used. In the examples and the comparative examples, LiPF₆ was used as the supporting salt of the nonaqueous electrolyte solution 18.

As shown in FIG. 4, in the examples and the comparative examples, the positive electrode density, the positive plate specific surface area, and the active material specific surface area were changed under the above-described conditions, and various determination results were studied. In the examples and the comparative examples, the relationship among the positive electrode density, the positive plate specific surface area, the active material specific surface area, the specific surface area difference, and the determination results of various characteristics were obtained.

The various characteristics include an internal resistance of the positive plate 30, overcharge allowance, and storage characteristics. The indicators of the determination results and the determination results for each of the indicators are shown. As for the internal resistance of the positive plate 30, it was determined whether the internal resistance at very low temperatures was in an appropriate range. As for the overcharge allowance, it was determined whether the time in which voltage increases from 4.75 V, which was the upper limit voltage, to 5.0 V was within an appropriate range. As for the storage characteristics, for example, it was determined whether the charge and discharge after storage over a period such as 30 days in a high-temperature environment, such as 70° C., was within an appropriate range. As for the indicators of the determination results, an appropriate range was indexed as a numerical value greater than or equal to 1, and is labeled as indicator in the drawing.

First, in Comparative Example 1, although the positive electrode density was in a range of 2.2 mg/cm³ to 3.0 mg/cm³, the specific surface area difference was larger than 1.8 m²/g and the active material specific surface area was smaller than 1.5 m²/g. In Comparative Example 1, none of the internal resistance, the overcharge allowance, and the storage characteristics of the positive plate 30 was determined to be in the appropriate range.

In Comparative Example 2, although the positive electrode density was in a range of 2.2 mg/cm³ to 3.0 mg/cm³, and the specific surface area difference was in a range of 0.66 m²/g to 1.8 m²/g, the active material specific surface area was smaller than 1.5 m²/g. In Comparative Example 2, as in Comparative Example 1, none of the internal resistance, the overcharge allowance, and the storage characteristics of the positive plate 30 was determined to be in the appropriate range.

In Comparative Example 3, although the active material specific surface area was in a range of 1.5 m²/g to 3.0 m²/g, the positive electrode density was larger than 3.0 mg/cm³ and the specific surface area difference was larger than 1.8 m²/g. In Comparative Example 3, although the internal resistance of the positive plate 30 was determined to be in the appropriate range, neither the overcharge allowance nor the storage characteristics was determined to be in the appropriate range. The results of Comparative Example 4 were similar to those of Comparative Example 3.

In Comparative Example 5, the positive electrode density was smaller than 2.2 mg/cm³, the active material specific surface area was smaller than 1.5 m²/g, and the specific surface area difference was larger than 0.66 m²/g. In Comparative Example 5, although the overcharge allowance and the storage characteristics were each determined to be in the appropriate range, the internal resistance of the positive plate 30 was not determined to be in the appropriate range.

In contrast, in Examples 1 to 5, the positive electrode density was in a range of 2.2 mg/cm³ to 3.0 mg/cm³, and the active material specific surface area was in a range of 1.5 m²/g to 3.0 m²/g. The specific surface area difference was in a range of 0.66 m²/g to 1.8 m²/g. In Examples 1 to 5, the internal resistance, the overcharge allowance, and the storage characteristics of the positive plate 30 were all determined to be in the appropriate ranges.

<Study of Examples and Comparative Examples>

As described above, the internal resistance of the positive plate 30 was not determined to be in the appropriate range in Comparative Examples 1, 2, and 5. One of the reasons for this is considered to be the fact that the active material specific surface area was relatively small, so that the reaction area of the positive plate 30 was relatively small.

In particular, in Comparative Example 2, even through the positive electrode density and the specific surface area difference were in the appropriate ranges, the active material specific surface area was relatively small, and the overcharge allowance and the storage characteristics were not determined to be in the appropriate ranges. In Comparative Example 1, not only was the active material specific surface area relatively small, but also the specific surface area difference was relatively large. In Comparative Example 5, not only was the active material specific surface area relatively small, but also the positive electrode density and the specific surface area difference were relatively small.

In Comparative Examples 3 and 4, even though the active material specific surface area was in the appropriate range, the positive plate specific surface area and the positive electrode density were relatively large, and the specific surface area difference was relatively large. The overcharge allowance and the storage characteristics were not determined to be in the appropriate ranges. One of the reasons for this is considered to be the fact that the positive electrode active material was crushed by pressing the positive electrode mixture layer 32 in the pressing step, and thus the number of newly formed surfaces of the positive electrode active material was relatively large.

In Comparative Examples 1 and 2, although the active material specific surface area was relatively small, the positive electrode density was not relatively small and was adjusted to an appropriate range by pressing. For this reason, in Comparative Examples 1 and 2, similarly to Comparative Examples 3 and 4, it is considered that the overcharge allowance and the storage characteristics were not determined to be in the appropriate ranges because of the large number of newly formed surfaces of the positive electrode active material.

<Formation of Newly Formed Surface>

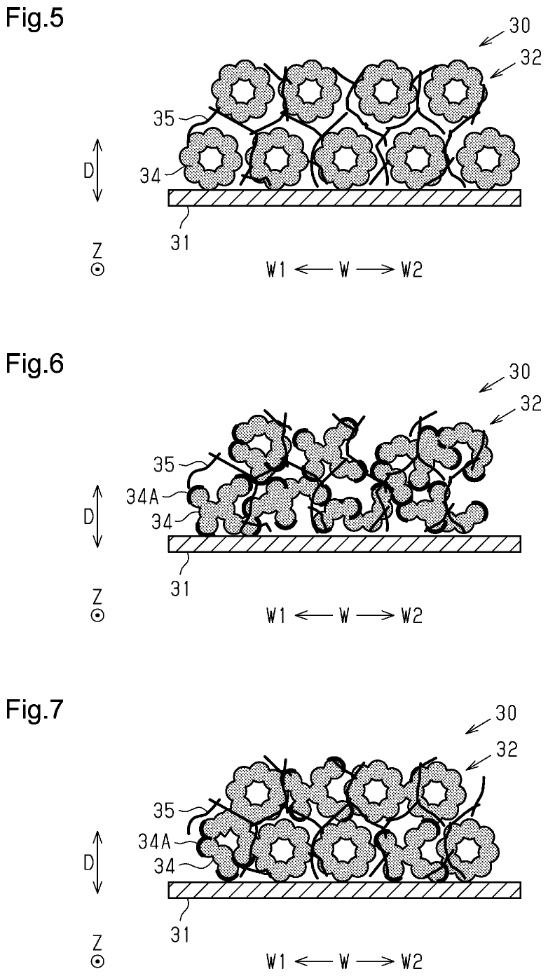

The formation of newly formed surface will now be described with reference to FIGS. 5 to 7. In FIGS. 5 to 7, the formation of newly formed surface is schematically illustrated in order to facilitate understanding of the disclosure.

As shown in FIG. 5, the positive electrode mixture layer 32 includes a positive electrode active material 34 and a positive electrode conductive material 35. Before manufacturing the positive plate 30, the positive electrode active material 34 is hollow particles with surfaces contacting air. The positive electrode active material 34 is thus in a chemically stable state.

As shown in FIGS. 6 and 7, the positive electrode active material 34 is crushed by being pressed in the pressing step. As a result, newly formed surfaces 34A are formed on the surfaces of the positive electrode active materials 34.

The newly formed surfaces 34A are surfaces that are not exposed to the outside before manufacturing the positive plate 30. The newly formed surfaces 34A are surfaces that are formed to be exposed to the outside by being pressed in the pressing step. The newly formed surfaces 34A are not in a chemically stable state and are highly activated, and may be a factor that lowers safety from the viewpoint of overcharge resistance. In addition, the newly formed surfaces 34A are likely to form irreversible films, which may cause deterioration in storage characteristics. The newly formed surfaces 34A are more likely to be formed as the specific surface area difference increases. Therefore, from the viewpoint of formation of the newly formed surfaces 34A, a new indicator of whether the specific surface area difference is within an appropriate range has been created.

As shown in FIG. 6, when a large number of the newly formed surfaces 34A are formed by pressing in the pressing step, the specific surface area difference increases. Thus, even if deterioration of the internal resistance is suppressed, the overcharge resistance and the storage characteristics may deteriorate.

On the other hand, when pressing is performed so that the number of the newly formed surfaces 34A is minimized in the pressing step, the specific surface area difference becomes too small. Thus, even if deterioration of the overcharge resistance and deterioration of the storage characteristics are suppressed, the internal resistance may deteriorate.

Therefore, if the number of the newly formed surfaces 34A formed by pressing in the pressing step is minimized as shown in FIG. 7, the specific surface area difference is in the appropriate range, and the internal resistance is prevented from deteriorating. Also, the overcharge resistance and the storage characteristics are prevented from deteriorating.

<Operation and Advantages of Present Embodiment>

Operation and advantages of the present embodiment will now be described.

(1) Particles of the positive electrode active material having a specific surface area of a range of 1.5 m²/g to 3.0 m²/g prior to manufacture of the positive plate 30 are used. The difference between the positive plate specific surface area and the active material specific surface area is in a range of 0.66 m²/g to 1.8 m²/g.

In the related art, the positive plate specific surface area is adjusted by pressing the positive electrode mixture layer 32 in the pressing step, and thus the internal resistance of the lithium-ion rechargeable battery 10 is prevented from deteriorating. However, in the related art, the formation of newly formed surfaces by pressing is not taken into consideration, and the overcharge resistance and the storage characteristics of the lithium-ion rechargeable battery 10 may be deteriorated.

In the present embodiment, the formation of newly formed surfaces by pressing is found to be one of the causes of the deterioration of the overcharge resistance and the deterioration of the storage characteristics of the lithium-ion rechargeable battery 10, and the new indicator as described above has been created. As a result, it is possible to suppress deterioration of the overcharge resistance and deterioration of the storage characteristics of the lithium-ion rechargeable battery 10 by minimizing the formation of newly formed surfaces of the positive electrode active material, while suppressing deterioration of the internal resistance of the lithium-ion rechargeable battery 10. This improves the characteristics of the lithium-ion rechargeable battery 10.

(2) The positive electrode density is in a range of 2.2 mg/cm³ to 3.0 mg/cm³. It is thus possible to suppress deterioration of the overcharge resistance and deterioration of the storage characteristics, while suppressing deterioration of the internal resistance of the lithium-ion rechargeable battery 10. This improves the characteristics of the lithium-ion rechargeable battery 10.

(3) The positive electrode active material is a ternary positive electrode active material. It is thus possible to suppress deterioration of the internal resistance of the lithium-ion rechargeable battery 10, deterioration of the overcharge resistance, and deterioration of the storage characteristics, while improving the charge/discharge cycle characteristics of the lithium-ion rechargeable battery 10, as compared with a positive electrode active material using lithium manganese oxide or the like. This improves the characteristics of the lithium-ion rechargeable battery 10.

(4) The positive electrode conductive material is one of carbon nanotubes or carbon nanofibers that have a specific surface area in a range of 150 m²/g to 300 m²/g prior to the manufacture of the positive plate 30. Accordingly, by using the positive electrode conductive material having a high conductivity, it is possible to suppress deterioration of the internal resistance of the lithium-ion rechargeable battery 10. This improves the characteristics of the lithium-ion rechargeable battery 10.

(5) The positive electrode mixture layer 32 is provided on the positive electrode substrate 31 by drying a positive electrode mixture paste applied to the positive electrode substrate 31. The positive electrode mixture paste contains at least a positive electrode active material and a positive electrode solvent. The positive electrode solvent is a nonaqueous solvent. This reduces a decrease in the amount of the positive electrode active material and reduces the specific surface area difference, as compared to a case in which an aqueous solvent is used. Accordingly, deterioration in the overcharge resistance is suppressed. This improves the characteristics of the lithium-ion rechargeable battery 10.

[Modifications]

The above-described embodiment may be modified as follows. The above-described embodiment and the following modifications can be combined as long as the combined modifications remain technically consistent with each other.

In the above-described embodiment, for example, the positive electrode active material, the positive electrode conductive material, the positive electrode solvent, and the positive electrode binder may be of any type.

In the above-described embodiment, for example, the positive electrode density is not limited if the active material specific surface area and the specific surface area difference are in the appropriate ranges. However, the positive electrode density is preferably in the appropriate range.

In the above-described embodiment, the lithium-ion rechargeable battery 10 has been described as an example of the present disclosure. However, the present disclosure is also applicable to other rechargeable batteries.

In the above-described embodiment, the thin plate-shaped lithium-ion rechargeable battery 10 to be mounted on a vehicle has been described as an example. However, the present disclosure is applicable to a columnar battery or the like. In addition, the present disclosure can be applied not only to batteries for vehicles but also to batteries for ships, aircrafts, and stationary batteries.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A positive plate for a nonaqueous rechargeable battery, comprising:
a positive electrode substrate; and
a positive electrode mixture layer that contains at least a positive electrode active material, wherein
particles of the positive electrode active material having a specific surface area of a range of 1.5 m²/g to 3.0 m²/g prior to manufacture of the positive plate for the nonaqueous rechargeable battery are used, and
a difference between a specific surface area of the positive plate for the nonaqueous rechargeable battery after manufacturing the positive plate for the nonaqueous rechargeable battery and the specific surface area of the particles of the positive electrode active material prior to manufacture of the positive plate for the nonaqueous rechargeable battery is in a range of 0.66 m²/g to 1.8 m²/g.

2. A nonaqueous rechargeable battery, comprising a positive plate, wherein
the positive plate includes:
a positive electrode substrate; and
a positive electrode mixture layer that contains at least a positive electrode active material,
particles of the positive electrode active material having a specific surface area of a range of 1.5 m²/g to 3.0 m²/g prior to manufacture of the positive plate are used, and
a difference between a specific surface area of the positive plate after manufacturing the positive plate and the specific surface area of the particles of the positive electrode active material prior to manufacture of the positive plate for the nonaqueous rechargeable battery is in a range of 0.66 m²/g to 1.8 m²/g.

3. A method of manufacturing a positive plate for a nonaqueous rechargeable battery, wherein
the positive plate for the nonaqueous rechargeable battery includes:
a positive electrode substrate; and
a positive electrode mixture layer that contains at least a positive electrode active material,
particles of the positive electrode active material having a specific surface area of a range of 1.5 m²/g to 3.0 m²/g prior to manufacture of the positive plate for the nonaqueous rechargeable battery are used, and
a difference between a specific surface area of the positive plate for the nonaqueous rechargeable battery after manufacturing the positive plate for the nonaqueous rechargeable battery and the specific surface area of the particles of the positive electrode active material prior to manufacture of the positive plate for the nonaqueous rechargeable battery is in a range of 0.66 m²/g to 1.8 m²/g.

4. The method of manufacturing the positive plate for the nonaqueous rechargeable battery according to claim 3, wherein a density of the positive electrode mixture layer is in a range of 2.2 mg/cm³ to 3.0 mg/cm³ after manufacturing the positive plate for the nonaqueous rechargeable battery.

5. The method of manufacturing the positive plate for the nonaqueous rechargeable battery according to claim 3, wherein the positive electrode active material is a ternary positive electrode active material.

6. The method of manufacturing the positive plate for the nonaqueous rechargeable battery according to claim 3, wherein
the positive electrode mixture layer includes a positive electrode conductive material, and
the positive electrode conductive material is one of carbon nanotubes or carbon nanofibers that have a specific surface area in a range of 150 m²/g to 300 m²/g prior to manufacture of the positive plate for the nonaqueous rechargeable battery.

7. The method of manufacturing the positive plate for the nonaqueous rechargeable battery according to claim 3, wherein
the positive electrode mixture layer is provided on the positive electrode substrate by drying a positive electrode mixture paste applied to the positive electrode substrate, the positive electrode mixture paste containing at least the positive electrode active material and a positive electrode solvent, and
the positive electrode solvent is a nonaqueous solvent.

8. A method of manufacturing a nonaqueous rechargeable battery including a positive plate, wherein
the positive plate includes:
a positive electrode substrate; and
a positive electrode mixture layer that contains at least a positive electrode active material,
particles of the positive electrode active material having a specific surface area of a range of 1.5 m²/g to 3.0 m²/g prior to manufacture of the positive plate are used, and
a difference between a specific surface area of the positive plate after manufacturing the positive plate and the specific surface area of the particles of the positive electrode active material prior to manufacture of the positive plate for the nonaqueous rechargeable battery is in a range of 0.66 m²/g to 1.8 m²/g.
